(19) United States
(12) Patent Application Publication
(10) Pub. No.: US 2024/0064041 A1
(43) Pub. Date: Feb. 22, 2024

(54) CONVEYOR SYSTEM, AN ELEVATOR SYSTEM, AND A CONVEYOR DEVICE

(71) Applicant: KONE CORPORATION, Helsinki (FI)

(72) Inventors: Nithil Karimpanackal Natarajan, Helsinki (FI); Mikko Piironen, Helsinki (FI)

(73) Assignee: KONE CORPORATION, Helsinki (FI)

(21) Appl. No.: 18/386,482

(22) Filed: Nov. 2, 2023

Related U.S. Application Data
(63) Continuation of application No. PCT/EP2021/066216, filed on Jun. 16, 2021.

(51) Int. Cl. H04L 12/46; B66B 1/34; B66B 25/00

(52) U.S. Cl. CPC H04L 12/4641; B66B 1/3453; B66B 25/003

(57) ABSTRACT

A conveyor system includes a conveyor control unit, one or more conveyor components, and a communication system for providing data frame-based communication between the conveyor control unit, the one or more conveyor components, and/or one or more external or remote systems. The communication system includes: at least two virtual local area networks (VLANs) separated by respective tags, a first switch device configured to connect the one or more conveyor components to at least one of the at least two VLANs, a second switch device configured to connect the conveyor control unit and the one or more external or remote systems to at least one of the at least two VLANs, and a trunk link configured to carry the data frames belonging to the at least two VLANs between the first switch device and the second switch device. An elevator system and a conveyor device are also discloses.

### TECHNICAL FIELD

The invention concerns in general the technical field of people and/or goods conveyor systems. Especially the invention concerns data communication of conveyor systems.

### BACKGROUND

Traditionally, in conveyor systems, e.g. in elevator systems, escalator systems, and moving walk systems, internal communication systems, i.e. communication systems interconnecting applications and devices of the people conveyor system, e.g. controllers, sensors, actuators etc., have been implemented with building automation networks, such as Controller Area Networks (CANs) or Local Operating networks (LONs). Typically, there are plurality of separate communication systems with different protocol stacks within the same conveyor system.

Typically, in case new devices and applications, e.g. info screens, need to access external data resources, separate data links are built by adding dedicated cabling or subscriber identification module (SIM) card. This results in a compli-cated and expensive system laborious to modify and to maintain.

Thus, there is a need to develop further solutions to improve data communication of conveyor systems.

### SUMMARY

The following presents a simplified summary in order to provide basic under-standing of some aspects of various invention embodiments. The summary is not an extensive overview of the invention. It is neither intended to identify key or critical elements of the invention nor to delineate the scope of the invention.

The following summary merely presents some concepts of the invention in a simplified form as a prelude to a more detailed description of exemplifying embodiments of the invention.

An objective of the invention is to present a conveyor system, an elevator system, and a conveyor device. Another objective of the invention is that the conveyor system, the elevator system, and the conveyor device enable an improved data communication.

The objectives of the invention are reached by a conveyor system, an elevator system, and a conveyor device as defined by the respective independent claims.

According to a first aspect, a conveyor system is provided, wherein the conveyor system comprises: a conveyor control unit, one or more conveyor components, and a communication system for providing data frame-based communication between the conveyor control unit, the one or more conveyor components, and/or one or more external or remote systems, wherein the communication system comprises: at least two virtual local area networks (VLANs) separated by respective tags, wherein the tag is applied to each data frame to direct the data frame to the VLAN corresponding to the tag; a first switch device configured to connect the one or more conveyor components to at least one of the at least two VLANs, a second switch device configured to connect the conveyor control unit and the one or more external or remote systems to at least one of the at least two VLANs, and a trunk link configured to carry the data frames belonging to the at least two VLANs between the first switch device and the second switch device.

The trunk link may be adapted to travel inside a cable arranged between the conveyor control unit and the one or more conveyor components.

The first switch device and/or the second switch device may be configured to: in response to receiving a data frame from the trunk link, identify the VLAN to which the data frame is directed based on the tag applied to the data frame; and/or in response to receiving a data frame from the one or more conveyor components, the conveyor control unit, and/or the one or more external or remote systems, apply a tag to the data frame to direct the data frame to the VLAN corresponding to the tag based on where the data frame is received from.

Furthermore, after the identifying the data frame the first switch device and/or the second switch device may further be configured to remove the tag from the data frame and to direct the data frame to the VLAN corresponding to the tag.

One VLAN of the at least two VLANs may be dedicated to a conveyor system related data communication.

At least one of the one or more conveyor components and the conveyor control unit may belong to the VLAN dedicated to the conveyor system related data communication.

Alternatively or in addition, the one or more external or remote systems may comprise at least one third-party system, wherein at least one VLAN of the at least two VLANs may be dedicated to a third-party system related data communication.

At least one of the one or more conveyor components and the at least one third-party system may belong to the VLAN dedicated to the third-party system related data communication.

Alternatively or in addition, the one or more external or remote systems may comprise one or more integration systems.

At least one of the one or more integration systems may belong to the VLAN dedicated to the conveyor system related data communication.

Alternatively or in addition, at least one VLAN of the at least two VLANs may be dedicated to an integration network related data communication.

The conveyor control unit and at least one of the one or more integration systems may belong to the VLAN dedicated to the integration network related data communication.

The communication system may further comprise a second trunk link connected between the second switch device and the conveyor control unit and configured to carry the data frames of at least the VLAN dedicated to the conveyor system related data communication and the VLAN dedicated to the integration network related data communication.

The one or more integration systems may comprise at least one of a remote conveyor control and monitoring system, a maintenance server, an access control system, a cloud network system, a building control system, a building automation system, a building management system, a Public Switched Telephone Network (PSTN) gateway system, and/or an external router system.

Alternatively or in addition, the one or more external or remote systems may comprise at least one other conveyor system, wherein at least one VLAN of the at least two VLANs may be dedicated to communication of the at least one other conveyor system, and wherein the at least one other conveyor system may belong to the at least one VLAN dedicated to the communication of the at least one other conveyor system.

The one or more conveyor components may comprise at least one of: at least one sensor device, at least one actuator device, at least one display, at least one imaging device, at least one emergency device, and/or at least one conveyor related device.

The conveyor system may be an elevator system, an escalator system, or a moving walk system.

According to a second aspect, an elevator system is provided, wherein the elevator system comprises: an elevator car arranged to travel along an elevator shaft between a plurality of landings, an elevator control unit, one or more elevator components arranged to the elevator car, and a communication system for providing data frame-based communication between the elevator control unit, the one or more elevator components, and/or one or more external or remote systems, wherein the communication system comprises: at least two virtual local area networks (VLANs) separated by respective tags, wherein the tag is applied to each data frame to direct the data frame to the VLAN corresponding to the tag; and a first switch device configured to connect the one or more elevator components to at least one of the at least two VLANs, a second switch device configured to connect the elevator control unit and the one or more external or remote systems to at least one of the at least two VLANs, and a trunk link configured to carry the data frames belonging to the at least two VLANs between the first switch device and the second switch device.

The trunk link may be adapted to travel inside a travelling cable arranged between the elevator control unit and the elevator car.

Alternatively, the trunk link may be a wireless trunk link.

According to a third aspect, a conveyor device is provided, in particular a conveyor control unit or a conveyor component, wherein the conveyor device is configured to communicate into a trunk link of a frame-based communication system of a conveyor system, wherein the conveyor device comprises: a switch device configured to connect the conveyor device to at least one VLAN of at least two VLANs of the communication system of the conveyor system separated by respective tags, and a processing unit communicatively connected to the switch device, wherein the communication into the trunk link comprises that the switch device is configured to apply to each data frame a tag to direct the data frame to the VLAN corresponding to the tag.

The conveyor component may be one of an elevator call-giving device, a display, a safety sensor, a safety brake, a position sensor, a drive unit of an elevator motor, an electronic safety control unit.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a conveyor system.

FIG. 2 illustrates schematically an example of a VLAN data frame.

FIG. 3 illustrates schematically another example of the conveyor system.

FIG. 4 illustrates schematically yet another example of the conveyor system.

FIG. 5 illustrates schematically yet another example of the conveyor system.

FIG. 6 illustrates schematically yet another example of the conveyor system.

FIG. 7A illustrates schematically an example an elevator system.

FIG. 7B illustrates schematically an example an escalator system.

FIG. 8 schematically illustrates an example of components of a conveyor device.

### DESCRIPTION OF THE EXEMPLIFYING EMBODIMENTS

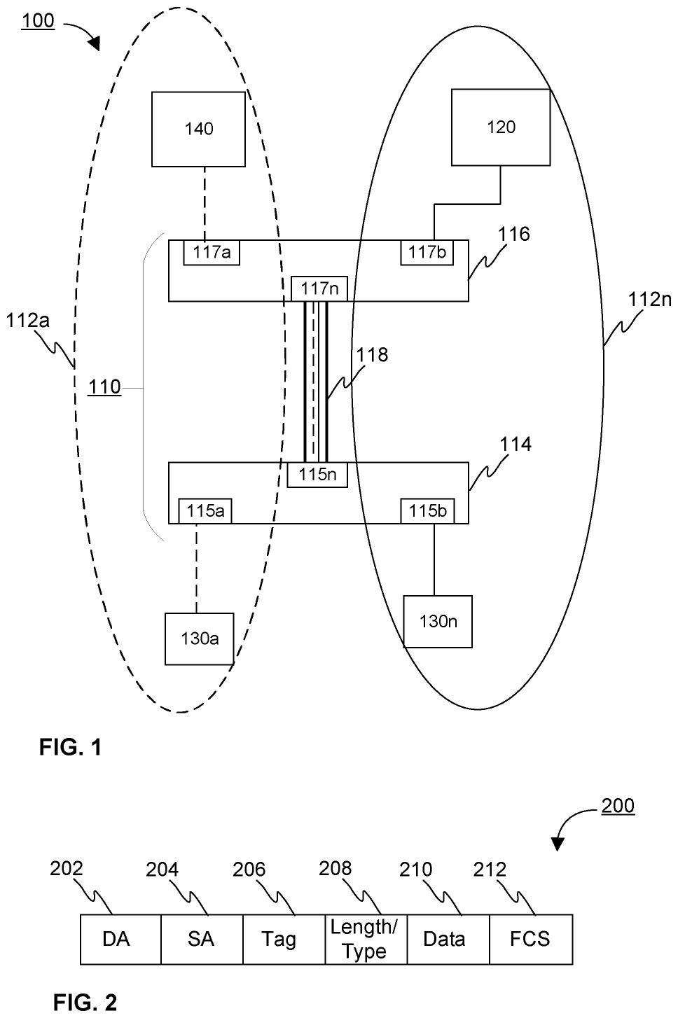

FIG. 1 illustrates schematically an example of a conveyor system 100 comprising a data frame-based communication system 110. The conveyor system 100 further comprises a conveyor control unit 120 and one or more conveyor components 130a-130n. The conveyor system 100 may be a people and/or goods conveyor system. More specifically, the conveyor system 100 may be an elevator system, an escalator system, or a moving walk system. The one or more conveyor components 130a-130n may comprise at least one of at least one sensor device, at least one actuator device, at least one screen, at least one imaging device, at least one emergency device, at least one processing unit, such as an artificial intelligence (AI) processing unit, and/or at least one other conveyor related device depending on the conveyor system 100. The different conveyor components 130a-130n of different kind of conveyor systems 100 will be discussed later in this application. The conveyor system 100 may further be associated with one or more external or remote systems 140, 140a-140d as will be discussed. The communication system 110 of the conveyor system 100 comprises 110 at least two virtual local area networks (VLANs) 112a-112n, a first switch device 114, a second switch device 116, and a trunk link 118. The example communication system 110 of FIG. 1 comprises two VLANs 112a and 112n. However, the communication system 110 may also comprise more than two VLANs 112a-112n. The communication system 110 is configured to provide data frame-based communication at least between the conveyor control unit 120, the one or more conveyor components 130a-130n, and/or the one or more external or remote systems 140, 140a-140d. The communication system 110 enables high bandwidth data communication at least between the conveyor control unit 120, the one or more conveyor components 130a-130n, and/or the one or more external or remote systems 140, 140a-140d.

The at least two VLANs 112a-112n are separated by respective tags 206. In other words, each VLAN 112a-112n of the at least two VLANs 112a-112n comprises a separate, i.e. an individual, tag 206 to separate the VLANs 112a-112n from each other. In the data frame-based communication, the tag 206 is applied to each data frame 200 to direct the data frame 200 to the VLAN 112a-112n corresponding to the tag 206. Different methods of VLAN tagging may be used. FIG. 2 illustrates schematically a non-limiting example of a VLAN data frame 200 realized by IEEE 802.1Q VLNA tagging method. The IEEE 802.1Q, also called “Dot One Q”, is the IEEE standard for tagging the data frames. In this method, a 4-byte tag 206 may be inserted into the frame 200 between a Source MAC address (SA) field 204 and a Length/Type field 208. The VLAN data frame 200 may further comprise a Destination MAC address (DA) field 202, a Data field 210, and a frame check sequence (FCS) field 212. The tag 206 may for example comprise VLAN ID (VID) field to identify the VLAN 112a-112n to which the data frame 200 belongs.

The first switch device 114 is configured to connect the one or more conveyor components 130a-130n to at least one of the at least two VLANs 112a-112n. The second switch device 116 is configured to connect the conveyor control unit 120 and the one or more external or remote systems 140, 140a-140d to at least one of the at least two VLANs 112a-112n. In addition, the first switch device 114 may be configured to connect one or more external or remote systems 140, 140a-140d to at least one of the at least two VLANs 112a-112n and/or the second switch device 116 may be configured to connect one or more conveyor components 130a-130n to at least one of the at least two VLANs 112a-112n. In the example of FIG. 1, the first switch device 114 connects the conveyor component 130a to the VLAN 112a and the conveyor component 130n to the VLAN 112n, and the second switch device 116, in turn, connects the external or remote system 140 to the VLAN 112a and the conveyor control unit 120 to the VLAN 112n. In other words, in the example of FIG. 1, the conveyor component 130a and the external or remote system 140 belong to the VLAN 112a and the conveyor component 130n and the conveyor control unit 120 belong to the VLAN 112n. The trunk link 118 is configured to carry the data frames 200 belonging to the at least two VLANs 112a-112n between the first switch device 114 and the second switch device 116. In other words, the trunk link 118 is capable to carry the data frames 200 belonging to the at least two VLANs 112a-112n between the first switch device 114 and the second switch device 116, e.g. in a shared data cable or a wireless link. In the example of FIG. 1, the trunk link 118 carries the data frames 200 belonging to the VLAN 112a and to the VLAN 112n between the first switch device 114 and the second switch device 116. The communication system 110 may further comprise at least one other trunk link, e.g. a second trunk link 518 as will be described later in this application.

The first switch device 114 and the second switch device 116 may comprise connection ports 115a-115n, 117a-117n to connect the different compo-nents/systems/units/devices/trunk links 118, 518. The switches 114, 116 may comprise one or more access ports and one or more tagged ports. The one or more access ports may be used to connect the components/systems/units, e.g. the one or more conveyor components 130a-130n, the one or more external or remote systems 140, 140a-140d, and/or the conveyor control unit 120, via communication links, e.g. access links, to gain access to the at least two VLANs 112a-112n. The access links may carry data frames 200 of only one VLAN 112a-112n. The one or more tagged ports may be used to connect the components/systems/devices/units, e.g. the first switch device 114, the second switch device 116, and/or the conveyor control unit 120, via the trunk links 118, 518. As discussed above, the trunk links 118, 518 may carry data frames 200 of more than one VLANs 112a-112n. The connection ports 115a-115n, 117a-117n may for example be Ethernet ports. In the example of FIG. 1, the first switch device 114 comprises an access port 115a for the conveyor component 130a, an access port 115b for the conveyor component 130n, and a tagged port 115n for the trunk link 118. In the example of FIG. 1, the second switch device 116 comprises an access port 117a for the external or remote system 140, an access port 117b for the conveyor control unit 120, and a tagged port 117n for the trunk link 118.

Next some examples of the data frame-based communication are discussed. In response to receiving, by the first switch device 114, a data frame 200 from the trunk link 118, the first switch device 114 may be configured to identify the VLAN 112a-112n to which the data frame 200 is directed based on the tag 206 applied to the data frame 200. After the identifying the data frame 200, the first switch device 114 may further be configured to remove the tag 206 from the data frame 200 and to direct the data frame 200 to the VLAN 112a-112n corresponding to the tag 206. For example, in the example of FIG. 1, if the first switch device 114 receives from the trunk link 118 a data frame 200 applied with a tag corresponding to the VLAN 112a, the first switch device 114 identifies the VLAN 112a based on the tag 206 applied to the data frame 200, removes the tag 206 from the data frame 200 and directs the data frame to the VLAN 112a corresponding to the tag 206. Alternatively or in addition, in response to receiving, by the first switch device 114, a data frame 200 from the one or more conveyor components 130a-130n, the first switch device 114 may be configured to apply a tag 206 to the data frame 200 to direct the data frame 200 to the VLAN 112a-112n corresponding to the tag 206 based on where the data frame 200 is received from. In other words, the first switch device 114 may be configured to apply the tag 206 to the data frame 200 received from the one or more conveyor components 130a-130n, wherein the applied tag 206 corresponds to the VLAN 112a-112n to which said one or more conveyor components 130a-130b belongs. For example, in the example of FIG. 1, if the first switch device 114 receives e.g. from the conveyor component 130n a data frame 200, the first switch device 114 applies a tag 206 corresponding to the VLAN 112n to the data frame 200 to direct the data frame 200 to the VLAN 112n corresponding to the tag 206. After applying the tag 206 to the data frame, the first switch device 114 passes the data frame 200 to the trunk link 118 to be passed on to the second switch device 116.

Similarly, in response to receiving, by the second switch device 116, a data frame 200 from the trunk link 118, the second switch device 116 may be configured to identify the VLAN 112a-112n to which the data frame 200 is directed based on the tag 206 applied to the data frame 200. After the identifying the data frame 200, the second switch device 116 may further be configured to remove the tag 206 from the data frame 200 and to direct the data frame 200 to the VLAN 112a-112n corresponding to the tag 206. For example, in the example of FIG. 1, if the second switch device 116 receives from the trunk link 118 a data frame 200 applied with a tag corresponding e.g. to the VLAN 112n, the second switch device 116 identifies the VLAN 112n based on the tag 206 applied to the data frame 200, removes the tag 206 from the data frame 200 and directs the data frame to the VLAN 112n corresponding to the tag 206. Alternatively or in addition, in response to receiving, by the second switch device 116, a data frame 200 from the conveyor control unit 120 or from the one or more external or remote system 140, 140a-140d, the second switch device 116 may be configured to apply a tag 206 to the data frame 200 to direct the data frame 200 to the VLAN 112a-112n corresponding to the tag 206 based on where the data frame 200 is received from. In other words, the second switch device 116 may be configured to apply the tag 206 to the data frame 200 received from the conveyor control unit 120 or from the one or more external or remote system 140, 140a-140d, wherein the applied tag 206 corresponds to the tag 206 of the VLAN 112a-112n to which said the conveyor control unit 120 or from the one or more external or remote system 140, 140a-140d belongs. For example, in the example of FIG. 1, if the second switch device 116 receives e.g. from the conveyor control unit 120 a data frame 200, the second switch device 116 applies a tag 206 corresponding to the VLAN 112n to the data frame 200 to direct the data frame 200 to the VLAN 112n corresponding to the tag 206. After applying the tag 206 to the data frame, the second switch device 116 passes the data frame 200 to the trunk link 118 to be passed on to the first switch device 114.

The first switch device 114 and the second switch device 116 may be switch devices with a VLAN capability. Preferably, the first switch device 114 and the second switch device 116 are Ethernet switch devices with the VLAN capability. Alternatively, the first switch device 114 and the second switch device 116 may be router devices or firewall device. The router devices and the firewall devices do not typically apply the tags 206 to the data frames 200, but are capable to identify, remove, and pass the tagged data frames 200.

The at least two VLANs 112a-112n may comprise VLANs dedicated to different data communications. For example, one VLAN may be dedicated to a conveyor system related data communication. Alternatively or in addition, at least one VLAN may dedicated to a third-party system related data communication. Alternatively or in addition, at least one VLAN may be dedicated to an integration network related data communication. Alternatively or in addition, at least one VLAN may be dedicated to data communication of at least one other conveyor system. Alternatively or in addition, one or more VLANs may be dedicated to any other data communication.

According to an example, at least one of the one or more conveyor compo-nents 130a-130n and the conveyor control unit 120 may belong to the VLAN dedicated to the conveyor system related data communication. For example, the VLAN 112n in the example of FIG. 1 may be the VLAN dedicated to the conveyor system related data communication and the conveyor control unit 120 and the conveyor component 130n belong to the VLAN 112n dedicated to the conveyor system related data communication.

According to another example, the one or more external or remote systems 140, 140a-140d may comprise at least one third-party system 140a that belongs to the VLAN dedicated to the third-party system related data communication. At least one of the one or more conveyor components 130a-130n may further belong to the VLAN dedicated to the third-party system related data communication.

According to yet another example, the one or more external or remote systems 140, 140a-140d may alternatively or in addition comprise one or more integration systems 140b, 140c. The one or more integration systems 140b, 140c may comprise at least one of a remote conveyor control and monitoring system, a maintenance server, an access control system, a cloud network system, a building control system, a building automation system, a building management system, a Public Switched Telephone Network (PSTN) gateway system, and/or an external router system.

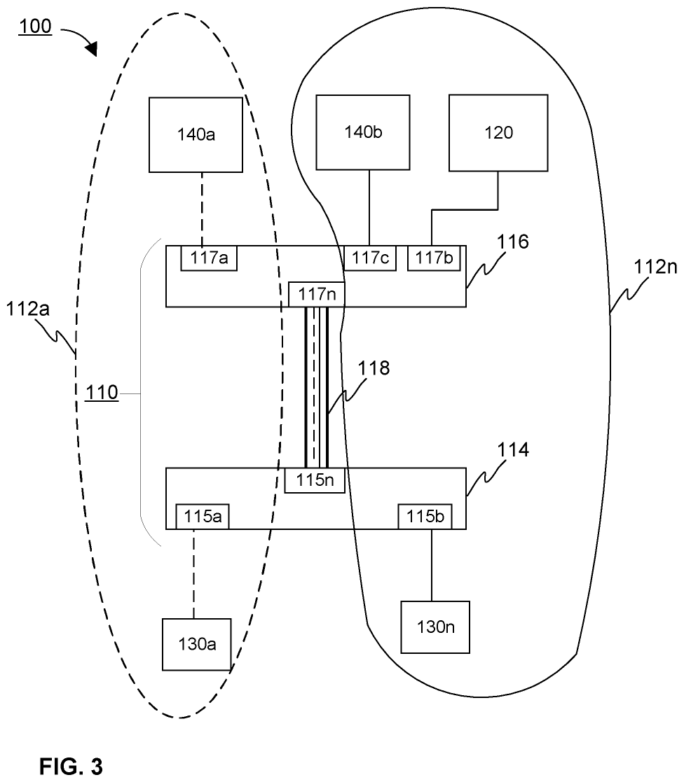

At least one of the one or more integration systems 140b, 140c may belong to the VLAN dedicated to the conveyor system related data communication. Alternatively or in addition, at least one of the one or more integration systems 140b, 140c may belong to the VLAN dedicated to the integration network related data communication. FIG. 3 illustrates schematically an example of the conveyor system 100, in which the one or more external remote systems 140, 140a-140d comprises one third-party system 140a and a first integration system 140b. The third-party system 140a may be connected to the second switch device 116 with an access port 117a and the first integration system 140b may be connected to the second switch device 116 with an access port 117c. In the example of FIG. 3 the VLAN 112a may be the VLAN dedicated to the third-party system related data communication and the VLAN 112n may be the VLAN dedicated to the conveyor system related data communication. The third-party system 140a and the conveyor component 130a belong to the VLAN 112a dedicated to the third-party system related data communication.

The conveyor component 130n, the conveyor control unit 120, and the first integration system 140b belong to the VLAN 112n dedicated to the conveyor system related data communication. Otherwise, the conveyor system 100 and the operations of the conveyor system 100 corresponds to the example conveyor system 100 of FIG. 1.

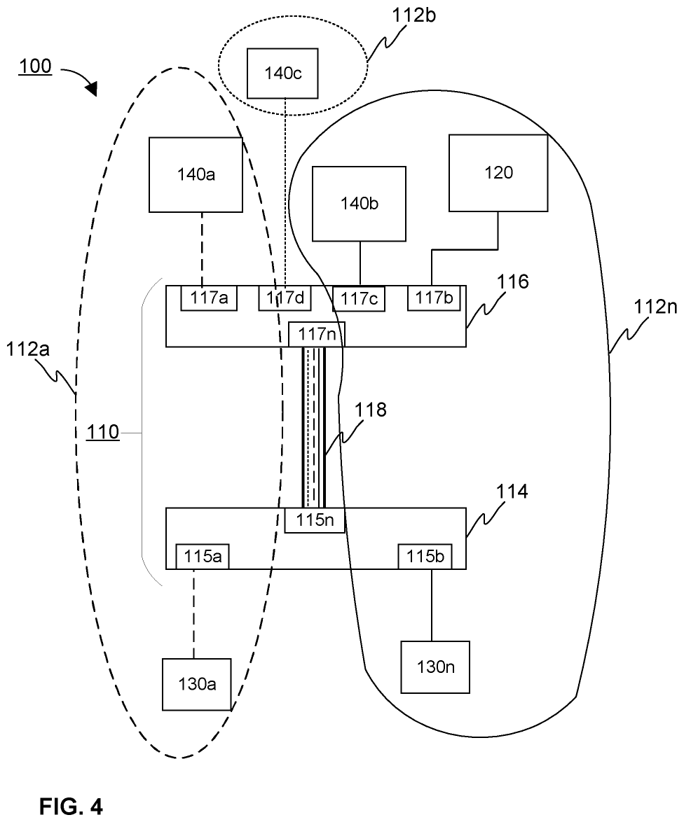

FIG. 4 illustrates schematically another example of the conveyor system 100. The conveyor system 100 of FIG. 4 is otherwise similar to the conveyor system 100 of FIG. 3, except the one or more external or remote systems 140, 140a-140d further comprises a second integration system 140c, which belongs to the VLAN 112b dedicated to the integration network related data communication. The second integration system 140c may be connected to the second switch device 116 with an access port 117d. For example, but not limited to, the first integration system 140b may be e.g. the PSTN gateway system and the second integration system 140c may be e.g. the remote conveyor control and monitoring system. In the example of FIG. 4, the trunk link 118 may carry the data frames 200 belonging to the VLANs 112a, 112b, and 112n, i.e. the VLAN 112a dedicated to the third-party system related data communication, the VLAN 112n dedicated to the conveyor system related data communication, and the VLAN 112b dedicated to the integration network related data communication, between the first switch device 114 and the second switch device 116. FIG. 4 illustrates only one example and the trunk link 118 may carry data frames 200 of any other VLANs. Alternatively or in addition, the communication system 110 may comprise any other number VLANs 112a-112n. Alternatively or in addition, the conveyor system 100 may comprise any other number of conveyor components 130a-130n. For example, the conveyor system 100 may alternatively or in addition comprise one or more conveyor components 130a-130n belonging to the VLAN 112b dedicated to the integration network related data communication. Alternatively or in addition, any other number of external or remote systems 140, 140a-140c and/or any other kind of external or remote systems 140, 140a-140c belonging to any other VLANs 112a-112n may be associated with and/or comprised by the conveyor system 100.

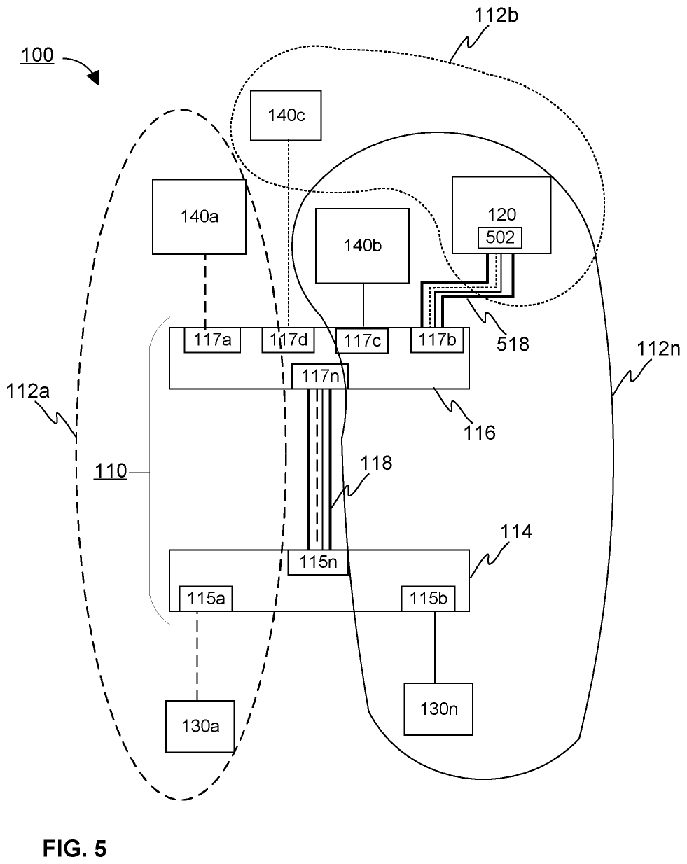

According to yet another example, the communication system 110 may further comprise a second trunk link 518 e.g. connected between the second switch device 116 and the conveyor control unit 120 to enable that the conveyor control unit 120 may belong to more than one VLAN 112a-112n. The second trunk link 518 may be configured to carry the data frames 200 belonging to at least two VLANs 112a-112n between the second switch device 116 and the conveyor control unit 120. The trunk link 118 and the second trunk link 118 may carry data frames 200 belonging to the same at least two VLANs 112a-112n and/or to different at least two VLANs 112a-112n. The control conveyor unit 120 may comprise an internal switch device 502. The internal switch device 502 may be configured to apply and/or identify and remove tags similarly as the first switch device 114 and the second switch device 116 described above. In other words, in response to receiving, by the internal switch device 502, a data frame 200 from the second trunk link 518, the internal switch device 520 may be configured to identify the VLAN 112a-112n to which the data frame 200 is directed based on the tag 206 applied to the data frame 200; and/or in response to receiving, by the internal switch device 502, a data frame 200 from the conveyor control unit 120, the internal switch device 502 may be configured to apply a tag 206 to the data frame 200 to direct the data frame 200 to the VLAN 112a-112n corresponding to the tag 206 based on where the data frame 200 is received from. For example, the conveyor control unit 120 may further belong to the VLAN dedicated to the integration network related data communication, in addition to belonging e.g. to the VLAN dedicated to the conveyor system related data communication. FIG. 5 illustrates schematically an example of the conveyor system 100, in which the conveyor control unit 120 belongs to the VLAN 112b dedicated to the integration network related data communication and to the VLAN 112n dedicated to the conveyor system related data communication. In the example of FIG. 5, the communication system 110 comprises the trunk link 118 between the first switch device 114 and the second switch device 116 and further the second trunk link 518 between the conveyor control unit 120 and the second switch device 116. In the example of FIG. 5, the trunk link 118 may carry data frames 200 of at least the VLAN 112b dedicated to the conveyor system related data communication and the VLAN 112a dedicated to the third-party system related data communication between the first switch device 114 and the second switch device 116 and the second trunk link 518 may carry data frames 200 of at least the VLAN 112b dedicated to the conveyor system related data communication and the VLAN 112b dedicated to the integration network related data communication between the conveyor control unit 120 and the second switch device 116. FIG. 5 illustrates only one example and the trunk link 118 and the second trunk link 518 may also carry data frames 200 of any other VLANs. Alternatively or in addition, the communication system 110 may comprise any other number VLANs 112a-112n. For example, the trunk link 118 may further carry data frames 200 the VLAN 112b dedicated to the integration network related data communication and the conveyor system 100 may further comprise one or more conveyor components 130a-130n belonging to the VLAN 112b dedicated to the integration network related data communication. Alternatively or in addition, the conveyor system 100 may comprise any other number of conveyor components 130a-130n. Alternatively or in addition, any other number of external or remote systems 140, 140a-140d and/or any other kind of external or remote systems 140, 140a-140d belonging to any other VLANs 112a-112n may be associated with and/or comprised by the conveyor system 100.

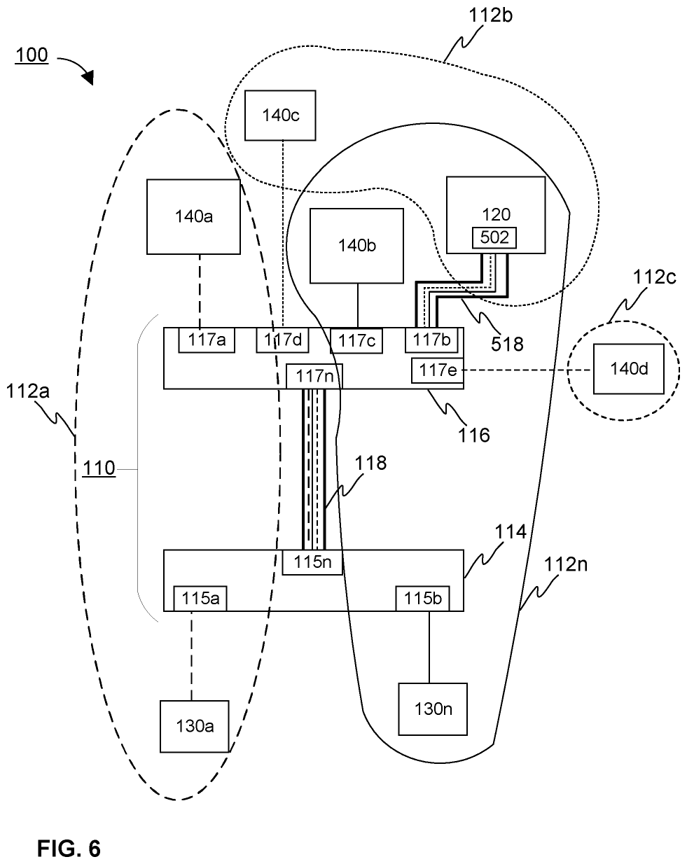

According to yet another example, the one or more external or remote systems 140, 140a-140d may alternatively or in addition comprise at least one other conveyor system 140d. The at least one other conveyor system 140d may comprise at least one elevator system, at least one escalator system, and/or at least one moving walk system. The at least one other conveyor system 140d may belong to the at least one VLAN dedicated to the communication of the at least one other conveyor system. FIG. 6 illustrates schematically an example of the conveyor system 100, which is otherwise similar to the conveyor system 100 of FIG. 5, but a second conveyor system 140d is associated with the conveyor system 100. FIG. 6 illustrates only one example of the conveyor system 100 with which the at least one other conveyor system 140d may be associated, but the at least one other conveyor system 140d may alternatively or in addition be associated with any of the example conveyor systems 100 discussed above referring to FIGS. 1, and/or 3-5. In the example of FIG. 6 the second conveyor system 140b belongs to the VLAN 112c dedicated to the communication of the at least one other conveyor system. In the example of FIG. 6, the trunk link 118 may carry data frames 200 of at least the VLAN 112b dedicated to the conveyor system related data communication, the VLAN 112a dedicated to the third-party system related data communication, and the VLAN 112c dedicated to the communication of the at least one other conveyor system between the first switch device 114 and the second switch device 116. The second conveyor system 140d may be connected to the second switch device 116 with an access port 117e.

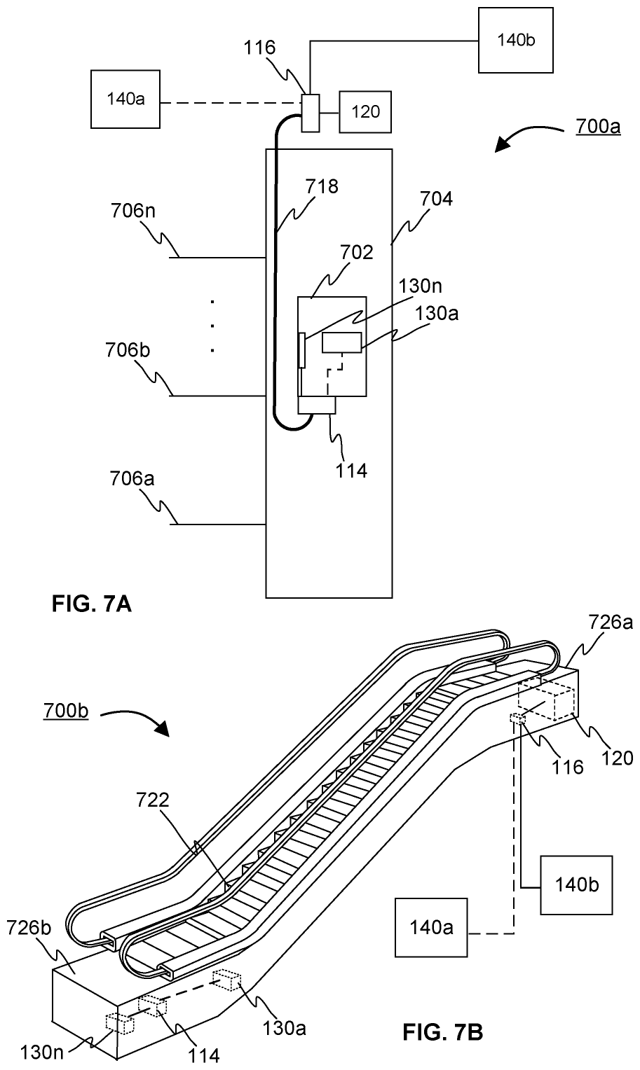

The trunk link 118 may be adapted to travel inside a cable, e.g. a shared data cable, arranged between the conveyor control unit 110 and the one or more conveyor components 130a-130n. If the conveyor system 100 is the elevator system, the cable may be the travelling cable of an elevator car. The travelling cable may be used in the elevator systems to connect electrical devices, e.g. the one or more conveyor components, in the elevator car to the conveyor control unit, e.g. an elevator control unit. If the conveyor system is the escalator system or the moving walk system, the cable may be a cable extending along an intermediate section arranged between two landings. The implementation of the data frame-based communication system 1100 in the elevator system 700a, the escalator system 700b, the moving walk system will be discussed next referring to FIGS. 7A and 7B.

FIG. 7A illustrates an example, wherein the conveyor system 100 is an elevator system 700a. The elevator system 700a comprises an elevator car 702 arranged to travel along an elevator shaft 704 between a plurality of landings 706a-706n, an elevator control unit 120 being the conveyor control unit 120 discussed above, and one or more elevator components 130a-130n being the one or more conveyor components 130a-130n discussed above. The one or more elevator components 130a-130n may be arranged to the elevator car 702 and/or associated with the elevator car 702. The example elevator system 700a of FIG. 7A comprises one elevator car 702 travelling along one elevator shaft 704, however the elevator system 700a may also comprise an elevator group, i.e. group of two or more elevator cars 702 each travelling along a separate elevator shaft 704 configured to operate as a unit serving the same landings 706a-706n. The elevator control unit 120 may be configured to control the operation of the elevator system 700a at least in part. The elevator control unit 120 may reside e.g. in a machine room (for sake of the clarity not shown in FIG. 7A) or in one of the landings 706a-706n of the elevator system 700a. The elevator system 700a may further comprise one or more other elevator related entities, e.g. hoisting system, safety circuit and devices, elevator door system, etc., which are not shown in FIG. 7A for sake of clarity. The elevator system 700a comprises the data frame-based communication system 110 discussed above. The communication system provides data frame-based communication at least between the elevator control unit 120, the one or more elevator components 130a-130n, and/or the one or more external or remote systems 140, 140a-140d. The communication system 110 of the elevator system 700a comprises at least two VLANs separated by respective tags, the first switch device 114 configured to connect the one or more elevator components 130a-130n to at least one of the at least two VLANs, the second switch device 116 configured to connect the elevator control unit 120 and the one or more external or remote systems 140, 140a-140d to at least one of the at least two VLANs, and the trunk link configured to carry the data frames 200 belonging to the at least two VLANs between the first switch device 114 and the second switch device 116 as discussed above. The trunk link 118 may be adapted to travel inside a travelling cable 718 arranged between the elevator control unit 120 and the elevator car 702. In the example of FIG. 7A, the travelling cable 718, inside which the trunk link 118 is arranged to travel, is illustrated. For sake of clarity the trunk link 118 is not illustrated in FIG. 7A. Alternatively, the trunk link 118 may be implemented as a wireless trunk link. To enable the wireless trunk link implementation, the first switch device 114 and the second switch device 116 may each comprise or be associated with a wireless communication device for providing a wireless communication connection for the wireless trunk link between the first switch device 114 and the second switch device 116. Alternatively, the elevator control unit 120 and the elevator car 702 or the one or more elevator components 130a-130n may each comprise or be associated with the wireless communication device for providing the wireless communication connection for the wireless trunk link between the first switch device 114 and the second switch device 116. In the example of FIG. 7A, the elevator system 100 is associated with two external or remote systems 140a, 140b, but the number or the external or remote systems 140a, 140b is not limited to that, and the elevator system 100 may be associated with and/or comprise any other number of external or remote systems 140a, 140b. In the example of FIG. 7A, one of the elevator components 130n, the elevator control unit 120, and the external or remote system 140b belong to the same VLAN (illustrated in FIG. 7A with solid connection lines), and one of the elevator components 130a and the external or remote system 140a belong to another VLAN (illustrated in FIG. 7A with dashed connection lines). The one or more elevator components 130a-130n may comprise, but is not limited to, an elevator call-giving device, a display, i.e. a screen, a safety sensor, a safety brake, a position sensor, a drive unit of an elevator motor, and/or an electronic safety control unit. For example, in the example of FIG. 7A, the elevator component 130n may be an elevator call-giving device, such as a car operation panel, and the elevator component 130a may be a third-party device, such as a display. FIG. 7A illustrates only one example implementation in the elevator system 700a, and one or more of the above-described implementation examples (e.g. examples of FIGS. 1, and/or 3-6) may be implemented in the elevator system 700a.

FIG. 7B illustrates an example, wherein the conveyor system 100 is an escalator system 700b. The escalator system 700b may comprise a conveying entity 722, an escalator control unit being the conveyor control unit 120 discussed above, and one or more escalator components 130a-130n being the one or more conveyor components 130a-130n discussed above. The escalator control unit 120 may be configured to control the operation of the escalator system 700b at least in part. The escalator control unit 120 may for example be arranged to one of platforms, i.e. landings, 726a, 726b of the escalator system 700b. In the example of FIG. 7B the escalator control unit 120 is arranged to a first platform, i.e. a top platform, 726a of the escalator system 700b. Alternatively, the escalator control unit 120 may be arranged to a second platform, i.e. a bottom platform, 726b of the escalator system 700b. The conveyor entity 722, i.e. a longitudinal intermediate section arranged between the platforms 726a, 726b, comprises steps arranged to an endless conveyor band, which is carried by a truss. The escalator system 700b may further comprise one or more other escalator related entities, e.g. a driving machine, etc., which are not shown in FIG. 7B for sake of clarity. The escalator system 700b comprises the data frame-based communication system 110 discussed above. The communication system 110 provides data frame-based communication at least between the escalator control unit 120, the one or more escalator components 130a-130n, and/or the one or more external or remote systems 140, 140a-140d. The communication system 110 of the escalator system 700b comprises at least two VLANs separated by respective tags, the first switch device 114 configured to connect the one or more escalator components 130a-130n to at least one of the at least two VLANs, the second switch device 116 configured to connect the escalator control unit 120 and the one or more external or remote systems 140a, 140b to at least one of the at least two VLANs, and a trunk link 118 configured to carry the data frames 200 belonging to the at least two VLANs between the first switch device 114 and the second switch device 116 as discussed above. The trunk link 118 may be adapted to travel inside a cable (not shown in FIG. 7B for sake of clarity) extending along the intermediate section 726 arranged between two platforms 726a, 726b. For sake of clarity the trunk link 118 is not illustrated in FIG. 7B. In the example of FIG. 7B, the escalator system 700b is associated with two external or remote systems 140a, 140b, but the number or the external or remote systems 140, 140a-140d is not limited to that, and the escalator system 700b may be associated with and/or comprise any other number of external or remote systems 140, 140a-140d. In the example of FIG. 7B, one of the escalator components 130n, the escalator control unit 120, and the external or remote system 140b belong to the same VLAN (illustrated in FIG. 7B with solid connection lines), and one of the escalator components 130a and the external or remote system 140a belong to another VLAN (illustrated in FIG. 7B with dashed connection lines). The one or more escalator components 130a-130n may comprise, but is not limited to, a display, i.e. a traffic light, a screen, a safety sensor, e.g. a missing or broken step detector, comb plate sensor, a safety brake, a handrail movement sensor, a position sensor, a load sensor, a proximity sensor, a pho-tocell, a camera, a drive unit of an escalator motor, and/or an electronic safety control unit. FIG. 7B illustrates only one example implementation in the escalator system 700b, and one or more of the above-described implementation examples (e.g. examples of FIGS. 1, and/or 3-6) may be implemented in the escalator system 700b.

As discussed above, the conveyor system 100 may also be a moving walk system. The moving walk system may comprise a conveying entity, a moving walk control unit being the conveyor control unit 120 discussed above, and one or more moving walk components 130a-130n being the one or more conveyor components 130a-130n discussed above. The moving walk system is otherwise similar to the escalator system 700b described above referring to FIG. 7B, but the conveyor entity of the moving walk system comprises pallets arranged to the endless conveyor band. Thus, the everything disclosed above referring to the escalator system 700b above applies also to the moving walk system. The moving walk system may be an inclined moving walk system, i.e. a moving walkaway system configured to convey people or goods across an inclined plane, e.g. between two platforms. Alternatively, the mowing walk system may be a horizontal moving walk system, i.e. a moving walk system configured to convey people or goods across a horizontal plane, e.g. between two platforms.

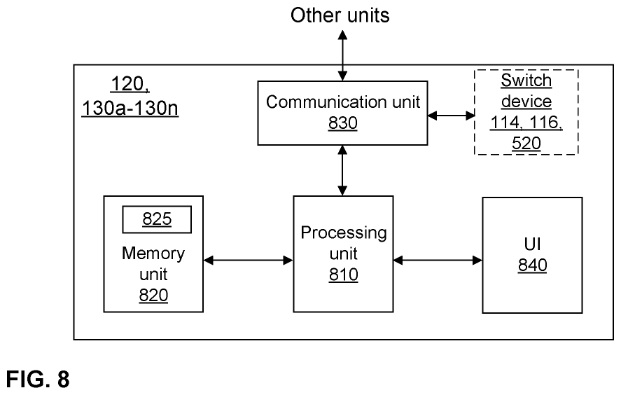

FIG. 8 schematically illustrates an example of components of a conveyor device 120, 130a-130n. The conveyor device may be the conveyor control unit 120, e.g. the elevator control unit, the escalator control unit or the moving walk control unit. Alternatively the conveyor device 120, 130a-130n may be the conveyor component 130a-130n, e.g. the elevator component, the escalator component, or the moving walk component. The conveyor device 120, 130a-130n may comprise a processing unit 810 comprising one or more processors, a memory unit 820 comprising one or more memories, a communication interface unit 830 comprising one or more communication devices, and possibly a user interface (UI) unit 840. The mentioned elements may be communicatively coupled to each other with e.g. an internal bus. The memory unit 820 may store and maintain portions of a computer program (code) 825 and any other data. The computer program 825 may comprise instructions which, when the computer program 825 is executed by the processing unit 810 of the conveyor device 120, 130a-130n may cause the processing unit 810, and thus the conveyor device 120, 130a-130n to carry out desired tasks, e.g. the operations of the conveyor device 120, 130a-130n described above. The processing unit 810 may thus be arranged to access the memory unit 820 and retrieve and store any information therefrom and thereto. For sake of clarity, the processor herein refers to any unit suitable for processing information and control the operation of the conveyor device 120, 130a-130n, among other tasks. The operations may also be implemented with a microcontroller solution with embedded software. Similarly, the memory unit 820 is not limited to a certain type of memory only, but any memory type suitable for storing the described pieces of information may be applied in the context of the present invention. The communication interface unit 830 provides one or more communication interfaces for communication with any other unit, e.g. another conveyor device 120, 130a-130n, the first switch device 114, the second switch device 116, the one or more external or remote systems 140, 140a-140d and/or any other units. The communication interface unit 830 may comprise one or more communication devices e.g. at least one transceiver circuit, at least one antenna, at least one communication port, etc. The user interface unit 840 may comprise one or more input/output (I/O) devices, such as buttons, keyboard, touch screen, mi-crophone, loudspeaker, display and so on, for receiving user input and output-ting information. The conveyor device 120, 130a-130n may further comprise the switch device 114, 116, 502. The switch device 114, 116, 502 may be an external switch device, such as the first switch device 114 and the second switch device 116 discussed above. Alternatively or in addition, the switch device 114, 116, 502 may be an internal switch device, such as the switch device 502 discussed above. The switch device 114, 116, 502 may be communicatively connected to the processing unit 810. The switch functionality of the switch device 114, 116, 502 may be implemented by at least one switch component having the VLAN capability. Alternatively or in addition, the switch functionality of the switch device 114, 116, 502 may be implemented by program-ming the switch functionality to a processing part that is communicatively connected to each communication port 115a-115n, 117a-117n of the switch device 114, 116, 502 via a transceiver circuit, e.g. a MAC/PHY transceiver chip, which does not have switch functionality. In case of the external switch device 114, 116, the switch device 114, 116 may comprise the processing part, e.g. a microcontroller. In case of the internal switch device 502, the processing part may be e.g. the processing unit 810 of the conveyor device. The computer program 825 may be a computer program product that may be comprised in a tangible non-volatile (non-transitory) computer-readable medium bearing the computer program code 825 embodied therein for use with a computer, i.e. the conveyor device 120, 130a-130n. The conveyor device 120, 130a-130n may be powered by mains, e.g. by wall plug. Alternatively, the conveyor device 120, 130a-130n may be powered by one or more batteries, i.e. the conveyor device 120, 130a-130n may be battery operated.

The above-described conveyor system 100 comprising the data frame-based communication system 110 with multiple VLANs enables an improved data communication at least between the conveyor control unit 120, the one or more conveyor components 130a-130n, and/or the one or more external or remote systems 140, 140a-140d.

The specific examples provided in the description given above should not be construed as limiting the applicability and/or the interpretation of the appended claims. Lists and groups of examples provided in the description given above are not exhaustive unless otherwise explicitly stated.

1. A conveyor system comprising:
a conveyor control unit;
one or more conveyor components; and
a communication system for providing data frame-based communication between the conveyor control unit, the one or more conveyor components, and/or one or more external or remote systems, wherein the communication system comprises:
at least two virtual local area networks (VLANs) separated by respective tags, wherein the tag is applied to each data frame to direct the data frame to the VLAN corresponding to the tag;
a first switch device configured to connect the one or more conveyor components to at least one of the at least two VLANs;
a second switch device configured to connect the conveyor control unit and the one or more external or remote systems to at least one of the at least two VLANs; and
a trunk link configured to carry the data frames belonging to the at least two VLANs between the first switch device and the second switch device.

2. The conveyor system according to claim 1, wherein the trunk link is adapted to travel inside a cable arranged between the conveyor control unit and the one or more conveyor components.

3. The conveyor system according to claim 1, wherein the first switch device and/or the second switch device is configured to:
in response to receiving a data frame from the trunk link, identify the VLAN to which the data frame is directed based on the tag applied to the data frame; and/or
in response to receiving a data frame from the one or more conveyor components, the conveyor control unit, and/or the one or more external or remote systems, apply a tag to the data frame to direct the data frame to the VLAN corresponding to the tag based on where the data frame is received from.

4. The conveyor system according to claim 3, wherein after the identifying the data frame, the first switch device and/or the second switch device is further configured to remove the tag from the data frame and to direct the data frame to the VLAN corresponding to the tag.

5. The conveyor system according to claim 1, wherein one VLAN of the at least two VLANs is dedicated to a conveyor system related data communication.

6. The conveyor system according to claim 5, wherein at least one of the one or more conveyor components and the conveyor control unit belong to the VLAN dedicated to the conveyor system related data communication.

7. The conveyor system according to claim 1, wherein the one or more external or remote systems comprise at least one third-party system, and wherein at least one VLAN of the at least two VLANs is dedicated to a third-party system related data communication.

8. The conveyor control system according to claim 7, wherein at least one of the one or more conveyor components and the at least one third-party system belong to the VLAN dedicated to the third-party system related data communication.

9. The conveyor system according to claim 5, wherein the one or more external or remote systems comprise one or more integration systems.

10. The conveyor system according to claim 9, wherein at least one of the one or more integration systems belongs to the VLAN dedicated to the conveyor system related data communication.

11. The conveyor system according to claim 9, wherein at least one VLAN of the at least two VLANs is dedicated to an integration network related data communication.

12. The conveyor system according to claim 11, wherein the conveyor control unit and at least one of the one or more integration systems belong to the VLAN dedicated to the integration network related data communication.

13. The conveyor system according to claim 12, wherein the communication system further comprises a second trunk link connected between the second switch device and the conveyor control unit and configured to carry the data frames of at least the VLAN dedicated to the conveyor system related data communication and the VLAN dedicated to the integration network related data communication.

14. The conveyor system according to claim 9, wherein the one or more integration systems comprises at least one of a remote conveyor control and monitoring system, a maintenance server, an access control system, a cloud network system, a building control system, a building automation system, a building management system, a Public Switched Telephone Network gateway system, and/or an external router system.

15. The conveyor system according to claim 1, wherein the one or more external or remote systems comprise at least one other conveyor system, wherein at least one VLAN of the at least two VLANs is dedicated to communication of the at least one other conveyor system, and wherein the at least one other conveyor system belongs to the at least one VLAN dedicated to the communication of the at least one other conveyor system.

16. The conveyor system according to claim 1, wherein the one or more conveyor components comprise at least one of at least one sensor device, at least one actuator device, at least one display, at least one imaging device, at least one emergency device, and/or at least one conveyor related device.

17. The conveyor system according to claim 1, wherein the conveyor system is an elevator system, an escalator system, or a moving walk system.

18. An elevator system comprising:
an elevator car arranged to travel along an elevator shaft between a plurality of landings;
an elevator control unit;
one or more elevator components arranged to the elevator car; and
a communication system for providing data frame-based communication between the elevator control unit, the one or more elevator components, and/or one or more external or remote systems, wherein the communication system comprises:
at least two virtual local area networks (VLANs) separated by respective tags, wherein the tag is applied to each data frame to direct the data frame to the VLAN corresponding to the tag; and
a first switch device configured to connect the one or more elevator components to at least one of the at least two VLANs;
a second switch device configured to connect the elevator control unit and the one or more external or remote systems to at least one of the at least two VLANs; and
a trunk link configured to carry the data frames belonging to the at least two VLANs between the first switch device and the second switch device.

19. The elevator system according to claim 18, wherein the trunk link is adapted to travel inside a travelling cable arranged between the elevator control unit and the elevator car.

20. The elevator system according to claim 19, wherein the trunk link is a wireless trunk link.

21. A conveyor device configured to communicate into a trunk link of a frame-based communication system of a conveyor system, wherein the conveyor device comprises:
a switch device configured to connect the conveyor device to at least one virtual local area network (VLAN) of at least two virtual local area networks (VLANs) of the communication system of the conveyor system separated by respective tags; and
a processing unit communicatively connected to the switch device,
wherein the communication into the trunk link comprises that the switch device is configured to apply to each data frame a tag to direct the data frame to the VLAN corresponding to the tag.

22. The conveyor device according to claim 21, wherein the conveyor device is a conveyor component, and the conveyor component is one of an elevator call-giving device, a display, a safety sensor, a safety brake, a position sensor, a drive unit of an elevator motor, an electronic safety control unit.
